(19) United States
(12) Patent Application Publication
(10) Pub. No.: US 2014/0025425 A1
(43) Pub. Date: Jan. 23, 2014

(54) BULK BUSINESS WORKFLOW SYSTEMS AND METHODS

(71) Applicants: Vikram CHALANA, Bothell, WA (US); Piyush NAGAR, Chandigarh (IN); Kumar PRABHAKAR, Chandigarh (IN); Vishal CHALANA, Chandigarh (IN)

(72) Inventors: Vikram CHALANA, Bothell, WA (US); Piyush NAGAR, Chandigarh (IN); Kumar PRABHAKAR, Chandigarh (IN); Vishal CHALANA, Chandigarh (IN)

(73) Assignee: WINSHUTTLE, LLC, Bothell, WA (US)

(21) Appl. No.: 13/551,509

(22) Filed: Jul. 17, 2012

(51) Int. Cl. G06Q 10/06

(52) U.S. Cl. 705/7.27

(57) ABSTRACT

A bulk-workflow server in communication with a bulk-workflow client may assist business users in completing multiple instances of a workflow task by transforming multiple instances of an individual workflow form into a single spreadsheet-like user interface with which a business user may simultaneously input, view, review/approve, and/or submit data for multiple instances of the workflow task.

### FIELD

The present invention relates to computer-mediated enterprise workflow processes, and more particularly to methods of automatically handling several parallel instances of a given workflow process.

### BACKGROUND

A business “workflow” typically includes a sequence of operational steps or tasks, at least some of which are assigned to a responsible person and/or group within an enterprise. In many cases, a task may be associated with a form document having fields in which a person may input, view, review/approve, and/or submit data associated with the task.

In some enterprises, such forms may obtain data from and/or submit data to an Enterprise resource planning (“ERP”) system, such as SAP ERP, provided by SAP AG of Weinheim, Germany. ERP systems are designed to coordinate some or all of the resources, information, and activities needed to complete business processes. An ERP system may support business functions including some or all of manufacturing, supply chain management, financials, projects, human resources, customer relationship management, and the like.

Moreover, many businesses operate an enterprise information portal (“EIP”) for integrating business information, people and processes across organizational boundaries. Many EIP systems allow businesses to provide and/or manage facilities such as some or all of intranets, extranets, websites, document and file management, collaboration spaces, social tools, enterprise search, business intelligence, process integration, system integration, workflow automation, and core infrastructure for third-party extensions. For example, many businesses use EIP systems such as Microsoft SharePoint, provided by Microsoft Corporation of Redmond, Wash.; SAP NetWeaver, provided by SAP AG of Weinheim, Germany; Sun Java System Portal Server, provided by Oracle Corporation or Redwood City, Calif.; and the like.

It is often possible for business users to create custom forms to enable users to perform specific transactions within the ERP system. And using facilities provided by an EIP system, it is often possible to enable users to perform such ERP transactions as part of an automated workflow system.

However, while forms-based automated workflow systems may be useful for automating individual transactions (e.g., procuring an individual part), in some cases, a business may need to perform many instances of a forms-based automated workflow in order to accomplish a broader business objective (e.g., manufacturing a device may require the procurement of dozens, hundreds, or thousands of individual parts). In such cases, it may be inconvenient to use existing automated workflow systems that require business users to interact with multiple individual instances of a form in order to perform a given task within multiple instances of a workflow.

### BRIEF DESCRIPTION OF THE DRAWINGS

FIG. 1 illustrates an exemplary bulk workflow system in accordance with one embodiment.

FIG. 2 illustrates several components of an exemplary bulk workflow server.

FIG. 3 illustrates several components of an exemplary client device.

FIG. 4 illustrates an exemplary series of communications between a client devices and bulk workflow server, in accordance with one embodiment.

FIG. 5 illustrates a bulk workflow management routine, such as may be performed by bulk workflow server in accordance with one embodiment.

FIG. 6 illustrates a bulk workflows initiation routine, such as may be performed by a client device in accordance with one embodiment.

FIG. 7 illustrates a subroutine for populating a spreadsheet-like user interface to collect input for a task of multiple workflow processes, such as may be performed by a client device in accordance with one embodiment.

FIG. 8 illustrates an in-process bulk workflows processing routine, such as may be performed by a client device in accordance with one embodiment.

FIG. 9, which illustrates an exemplary workflow designer user interface.

FIGS. 10-11 and 14 illustrate exemplary form views in accordance with one embodiment.

FIGS. 12-13 and 15 illustrate an exemplary spreadsheet user interface with a “Bulk Workflow” add-in in accordance with one embodiment.

### DESCRIPTION

The detailed description that follows is represented largely in terms of processes and symbolic representations of operations by conventional computer components, including a processor, memory storage devices for the processor, connected display devices and input devices. Furthermore, these processes and operations may utilize conventional computer components in a heterogeneous distributed computing environment, including remote file Servers, computer Servers and memory storage devices. Each of these conventional distributed computing components is accessible by the processor via a communication network.

Reference is now made in detail to the description of the embodiments as illustrated in the drawings. While embodiments are described in connection with the drawings and related descriptions, there is no intent to limit the scope to the embodiments disclosed herein. On the contrary, the intent is to cover all alternatives, modifications and equivalents. In alternate embodiments, additional devices, or combinations of illustrated devices, may be added to, or combined, without limiting the scope to the embodiments disclosed herein.

According to various embodiments, as described below, a bulk-workflow server in communication with a bulk-workflow client may assist business users in completing multiple instances of a workflow task by transforming multiple instances of an individual workflow form into a single spreadsheet-like user interface with which a business user may simultaneously input, view, review/approve, and/or submit data for multiple instances of the workflow task. In various embodiments, such workflow tasks and forms may interface with data stored in an ERP system, an EIP system, or other similar Enterprise Application system.

As the term is used herein, a spreadsheet-like user interface or “SLUI” refers to a user interface that presents editable and/or viewable cells organized in rows and columns as variously described herein. In some embodiments, a SLUI may be implemented via a plug-in, add-in, or other extension of a general-purpose spreadsheet application that operates on actual spreadsheet documents. In other embodiments, a SLUI may be implemented via a special-purpose desktop, mobile, and/or web application that makes use of cells organized in rows and columns and that may make use of common spreadsheet conventions for populating cell contents via formulas, references to other cells, and/or automated “fill” operations (e.g., fill down, fill right).

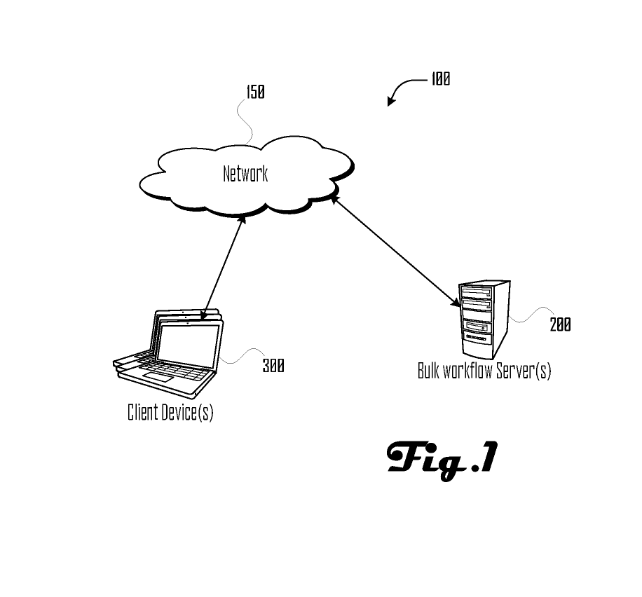

FIG. 1 illustrates an exemplary bulk workflow system 100 in which one or more client devices 300 and one or more bulk workflow server(s) 110 are connected to a network 150. In some embodiments, many additional devices (not shown) may be present, such as ERP servers, application servers, EIP servers, and the like.

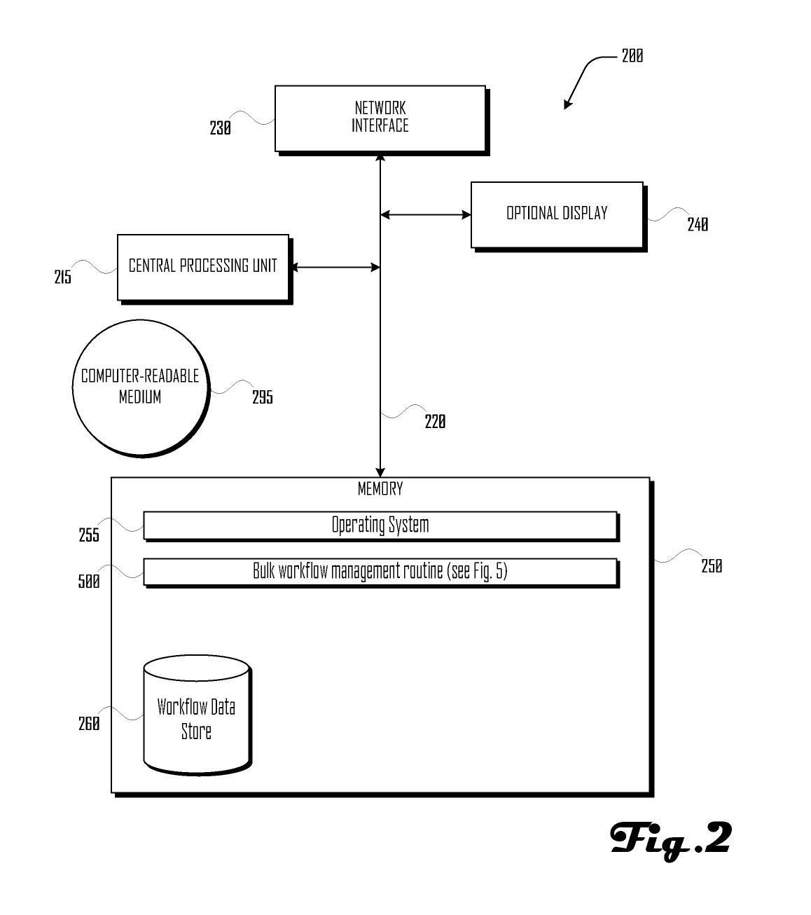

FIG. 2 illustrates several components of an exemplary bulk workflow server 200. In some embodiments, bulk workflow server 200 may include many more components than those shown in FIG. 2. However, it is not necessary that all of these generally conventional components be shown in order to disclose an illustrative embodiment. As shown in FIG. 2, the bulk workflow server 200 includes a network interface 230 for connecting to the network 150.

The bulk workflow server 200 also includes a processing unit 210, a memory 250, and an optional display 240, all interconnected along with the network interface 230 via a bus 220. The memory 250 generally comprises a random access memory (“RAM”), a read only memory (“ROM”), and a permanent mass storage device, such as a disk drive. The memory 250 stores program code for bulk workflow management routine 500. In addition, the memory 250 also stores an operating system 255. These software components may be loaded from a non-transient computer readable storage medium 295 into memory 250 of the bulk workflow server 200 using a drive mechanism (not shown) associated with a non-transient computer readable storage medium 295, such as a floppy disc, tape, DVD/CD-ROM drive, memory card, or other like storage medium. In some embodiments, software components may also or instead be loaded via a mechanism other than a drive mechanism and computer readable storage medium 295 (e.g., via network interface 230).

Bulk workflow server 200 also communicates via bus 220 with workflow data store 260. In various embodiments, bus 220 may comprise a storage area network (“SAN”), a high speed serial bus, and/or via other suitable communication technology. In some embodiments, bulk workflow server 200 may communicate with workflow data store 260 via network interface 230.

Although an exemplary bulk workflow server 200 has been described that generally conforms to conventional general purpose computing devices, an bulk workflow server 200 may be any of a great number of devices capable of communicating with the network 150, for example, a personal computer, a game console, a set-top box, a handheld computer, a cell phone, or any other like device.

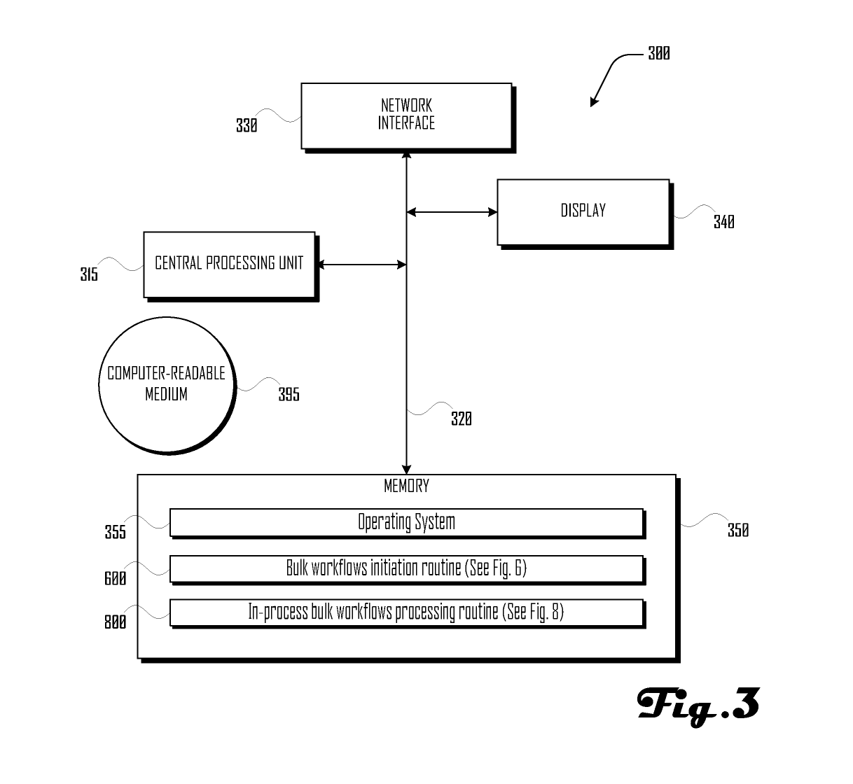

FIG. 3 illustrates several components of an exemplary client device 300. In some embodiments, client device 300 may include many more components than those shown in FIG. 3. However, it is not necessary that all of these generally conventional components be shown in order to disclose an illustrative embodiment. As shown in FIG. 3, the client device 300 includes a network interface 330 for connecting to the network 150.

The client device 300 also includes a processing unit 310, a memory 350, and a display 340, all interconnected along with the network interface 330 via a bus 320. The memory 350 generally comprises a random access memory (“RAM”), a read only memory (“ROM”), and a permanent mass storage device, such as a disk drive. The memory 350 stores program code for bulk-workflow initiation routine 600 and existing-bulk-workflows processing routine 800. In addition, the memory 350 also stores an operating system 355. These software components may be loaded from a non-transient computer readable storage medium 395 into memory 350 of the client device 300 using a drive mechanism (not shown) associated with a non-transient computer readable storage medium 395, such as a floppy disc, tape, DVD/CD-ROM drive, memory card, or other like storage medium. In some embodiments, software components may also or instead be loaded via a mechanism other than a drive mechanism and computer readable storage medium 395 (e.g., via network interface 330).

Although an exemplary client device 300 has been described that generally conforms to conventional general purpose computing devices, an client device 300 may be any of a great number of devices capable of communicating with the network 150 and/or bulk workflow server 200, for example, a personal computer, a game console, a set-top box, a handheld computer, a cell phone, or other like device.

FIG. 4 illustrates an exemplary series of communications between a client device 300A operated by a first business actor, client device 300B operated by a second business actor, and bulk workflow server 200, in accordance with one embodiment. Beginning the illustrated sequence of operations, an “originating” business actor (operating client device 300A) sends to bulk workflow server 200 a request 403 to identify available workflow initial forms (forms that can be used to initiate a workflow process).

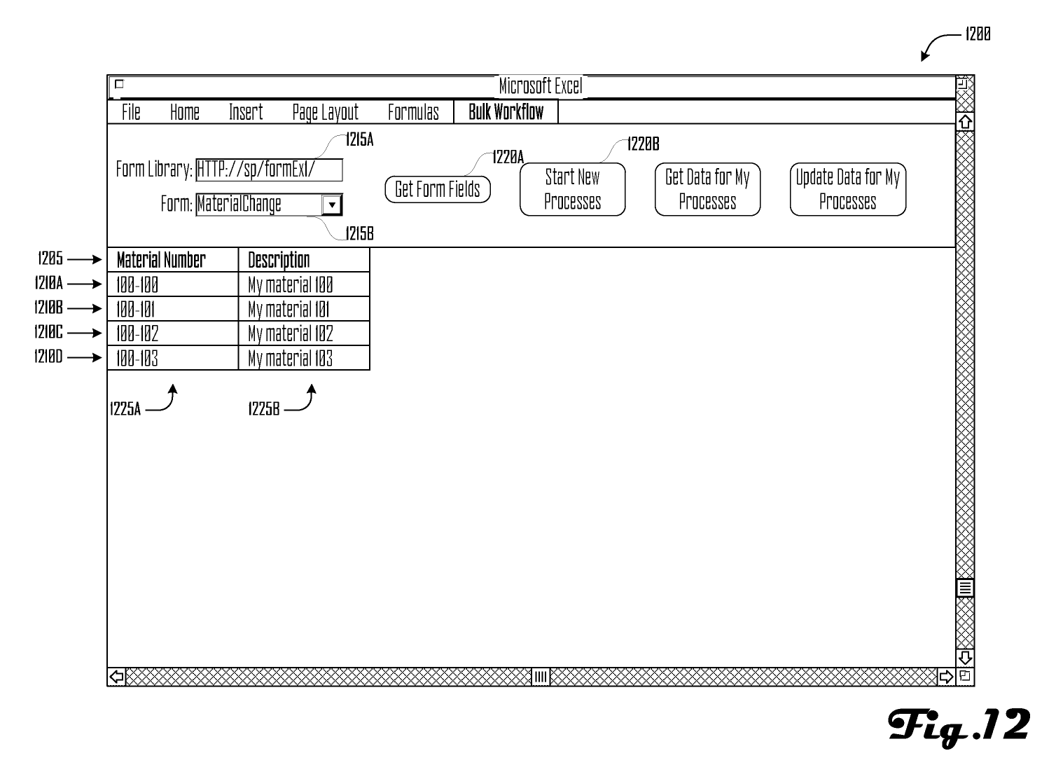

For example, FIG. 12 illustrates an exemplary spreadsheet user interface 1200 with a “Bulk Workflow” add-in with a field 1215A for identifying a “Form Library” (e.g., bulk workflow server 200), and a control 1215B that is populated with a list of forms available in the indicated form library. In one embodiment, the “Bulk Workflow” may send to bulk workflow server 200 a request 403 to identify available workflow initial forms to populate control 1215B.

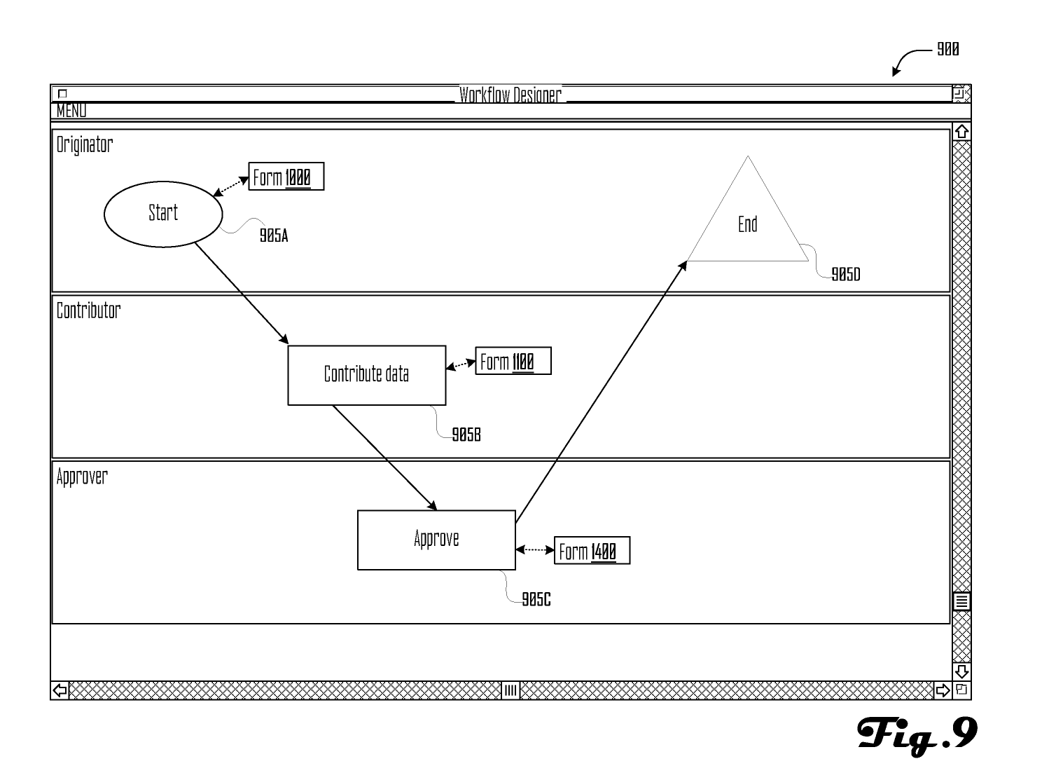

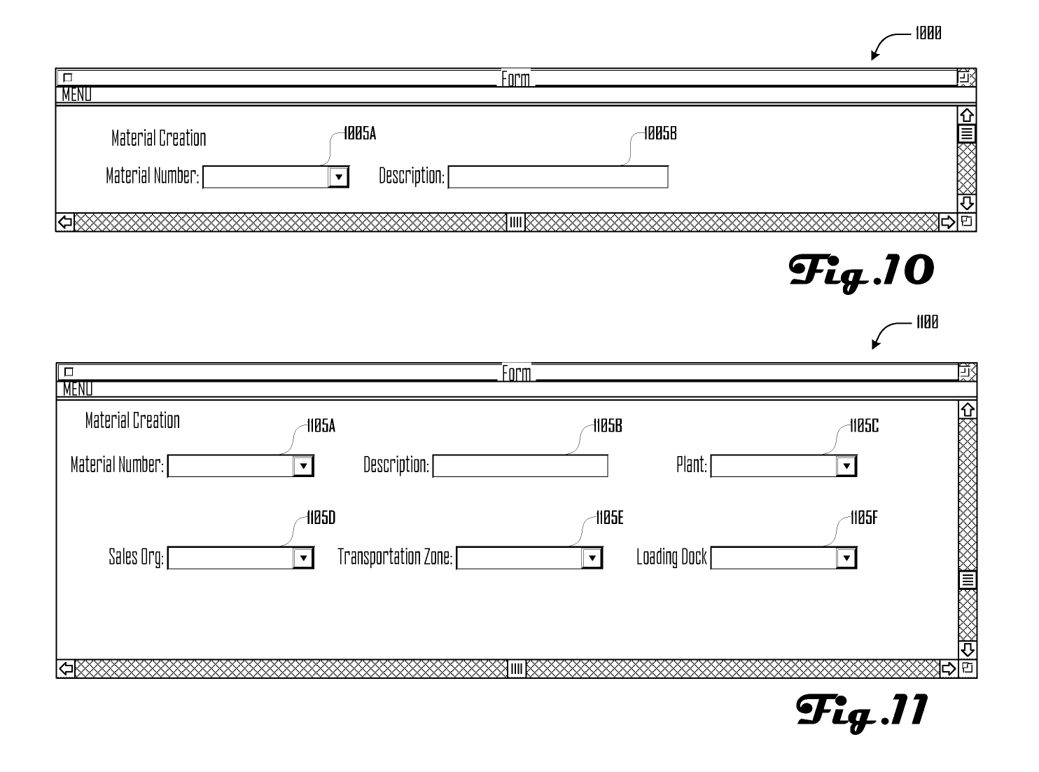

Referring again to FIG. 4, bulk workflow server 200 identifies one or more pre-defined workflows (e.g., by querying workflow data store 260) and their associated forms. For example, in one embodiment, a workflow may be defined using a user interface similar to that illustrated in FIG. 9, which illustrates an exemplary workflow designer user interface 900. User interface 900 shows an exemplary workflow having a “Start” task 905A (which is associated with form 1000, see FIG. 10, discussed below), a “Review” task 905B and a “View” task 905C (which are associated with form 1100, see FIG. 11, discussed below), and an “End” task 905D.

In various embodiments, a forms-authoring tool such as Microsoft InfoPath forms, provided by Microsoft Corporation of Redmond, Wash., may be used to define forms having fields linked to a web service, application programming interface (“API”), pre-recorded ERP transaction and/or other interface to access and/or update data stored in pre-defined ERP tables or fields. In other embodiments, other forms-authoring tools may be employed. For example, in various embodiments, a form may be generated using a tool such as LiveCycle Designer, provided by Adobe Systems Incorporated of Mountain View, Calif.; a Windows Forms application, such as Microsoft Visual Studio, also provided by Microsoft Corporation of Redmond, Wash.; a mobile forms builder, such as Canvas, provided by Canvas Solutions, Inc. of Herndon, Va.; and/or a web-form builder, such as Oracle Application Express (APEX), provided by Oracle Corporation of Redwood Shores, Calif.

Referring again to FIG. 4, when identifying one or more pre-defined workflows and their associated forms, bulk workflow server 200 may identify the workflow shown in user interface 900 and form 1000, which is associated with the first task of the workflow.

Bulk workflow server 200 sends to client device 300A one or more identifiers corresponding to the identified forms. Client device 300A presents 408 the identified forms to the business actor and obtains a selection of the form/workflow that the business actor wishes to begin, as well as an indication to obtain form fields of the selected form. For example, in the exemplary user interface 1200 shown in FIG. 12, a business actor has selected the “MaterialChange” form using control 1215B. The business actor may indicate that the “Bulk Workflow” add-in should obtain form fields of the “MaterialChange” form by activating control 1220A.

Referring again to FIG. 4, client device 300A sends to bulk workflow server 200 a request 410 for the fields of the selected form. Bulk workflow server 200 processes the request 413 and sends the requested form fields 415 to client device 300A. For example, as illustrated in FIG. 10, form 1000 includes fields 1005A and 1005B, each of which is associated with various attributes and/or metadata, which may include a list of input restrictions and/or a rule or rules for validating input to the field. When responding to a request for fields associated with form 1100, bulk workflow server 200 may send data describing fields 1005A and 1005B, as well as any associated restrictions, validation rules, and/or other metadata.

Referring again to FIG. 4, having received information describing form fields of the selected form, client device 300A initializes 418 a spreadsheet-like user interface (“SLUT”) corresponding to the form and automatically populates 420 column headers with form-field descriptions. For example, as illustrated in FIG. 12, having received describing form fields of the selected form, client device 300A may initialize a spreadsheet document having at least two columns (1225A-B) and populate the first row 1205 of each column with a description of a corresponding form field.

Referring again to FIG. 4, client device 300A receives input 423 from the business actor to populate two or more non-header rows in the SLUT and to create new workflow processes corresponding to the two or more non-header rows. For example, as illustrated in FIG. 12, client device 300A may receive data (e.g. “100-100”, “My material 100”, and the like) to populate columns 1225A-B of rows 1210A-D. The business actor may use control 1220B to indicate that new workflow processes corresponding to the entered data should be created.

Referring again to FIG. 4, client device 300A validates 425 the entered data using rules, logic, and/or restrictions (if any) that are present in the underlying form and sends 428 the validated rows of input data to bulk workflow server 200. Bulk workflow server 200 initiates a parallel group of workflow processes, processing each individual row of input data as if the remote business actor had completed an individual instance of the corresponding form. In some embodiments, in the course of initiating the workflow processes some or all of the input data may be persisted to workflow data store 260, an ERP server, and/or an EIP server.

Bulk workflow server 200 then identifies 433 the form (or form view) that is associated with the next task in the newly creates group of parallel workflow processes, and bulk workflow server 200 identifies a business actor to whom the next task is assigned. For example, when processing workflows such as that illustrated in FIG. 9, bulk workflow server 200 may identify task 905 as the next task in the workflows, which is associated with form 1100 (see FIG. 11). Using metadata associated with task 905B in the workflow definition (not shown), bulk workflow server 200 may be able to identify a business actor who should complete task 905B.

Referring again to FIG. 4, in the illustrated scenario, bulk workflow server 200 has identified an “approving” business actor who operates client device 300B as being assigned to the next workflow task. Consequently, bulk workflow server 200 sends to client device 300B a notification 435 that the approving business actor has a group of parallel workflow processes with tasks pending.

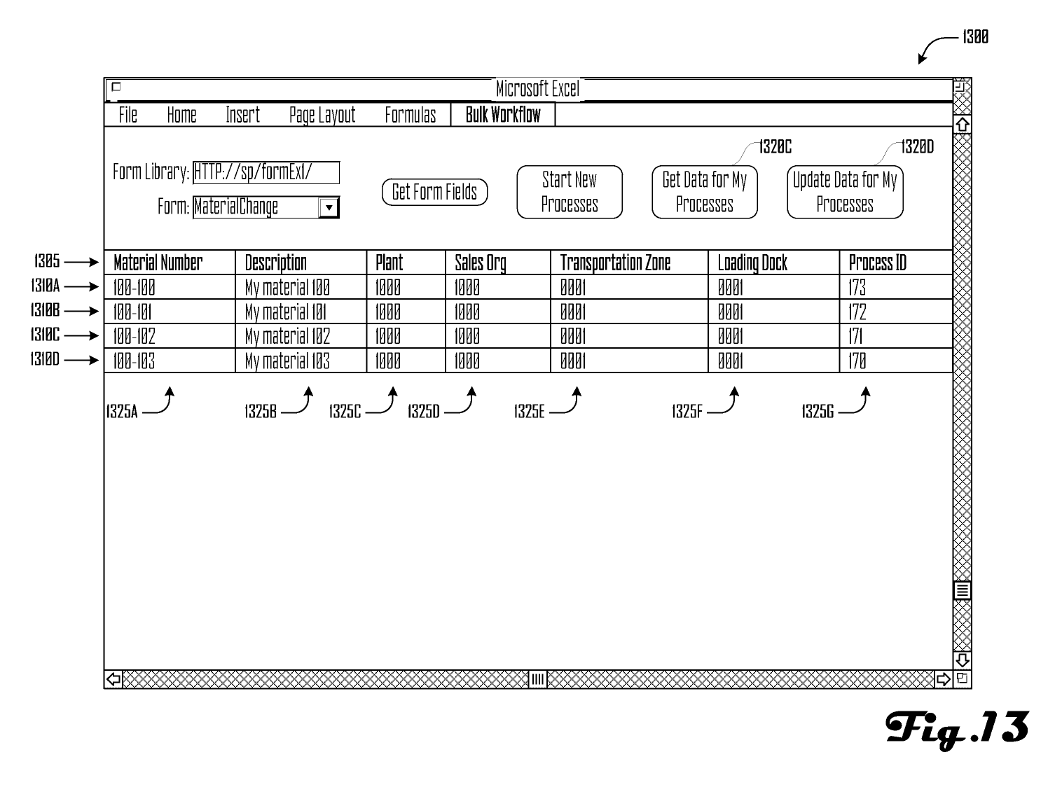

In the illustrated scenario, the notification may prompt the approving business actor to activate a SLUI such as SLUI 1300 shown in FIG. 13 (implemented as an add-in to a desktop spreadsheet application) and request data 438 for the pending workflow tasks using control 1320C.

Bulk workflow server 200 processes 440 the request and sends to client device 300B rows of data corresponding to those entered by the originating business actor via client device 300A. Upon receiving the pending workflow data, client device 300B initializes a SLUT corresponding to the form associated with the next workflow task and populates it with the workflow data. For example, client device 300B may initialize a SLUI such as SLUI 1300 shown in FIG. 13, populate columns 1325A-G of header row 1305, populate columns 1325A-B of data rows 1310A-D with data that was entered via SLUI 1200, and populate column 1325G with workflow process identifiers generated by the workflow system.

Referring again to FIG. 4, client device 300B receives 448 and validates input from the approving business actor. For example, in the example illustrated in FIG. 13, the business actor may enter data into columns 1325C-F of data rows 1310A-D.

Referring again to FIG. 4, client device 300B sends the data thus obtained 450 to bulk workflow server 200 for further processing until the workflow processes are completed.

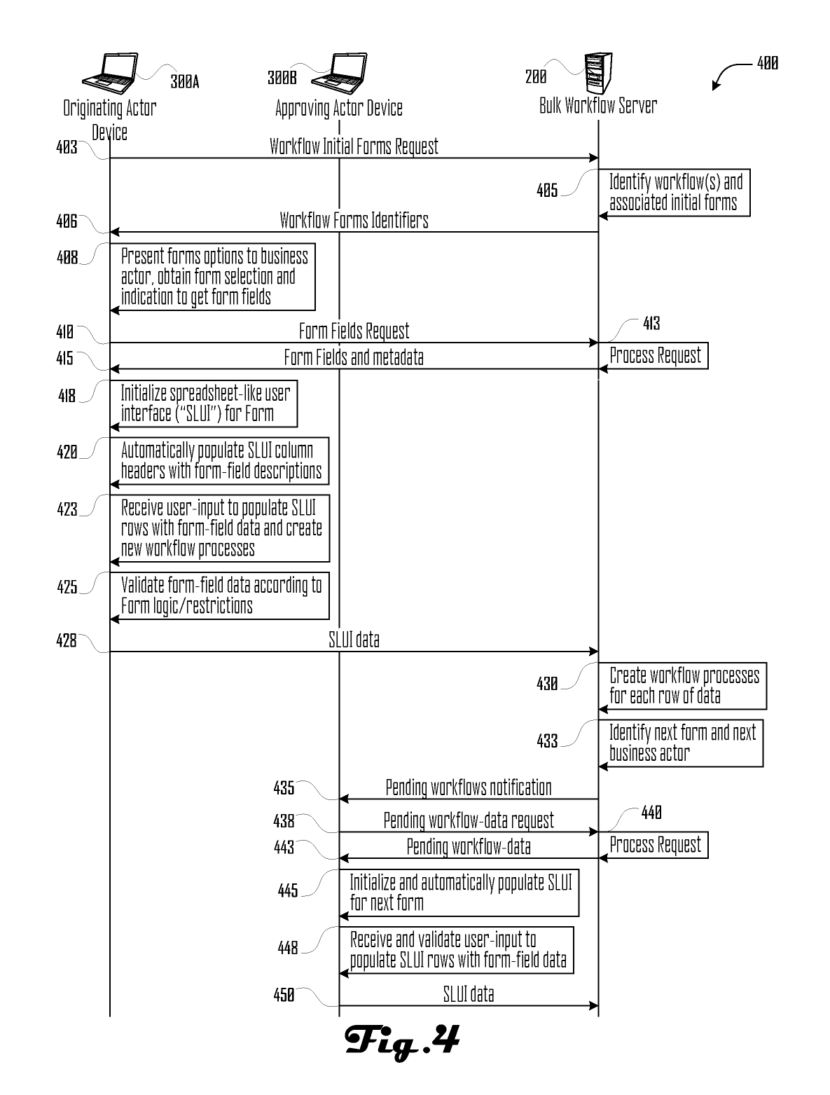

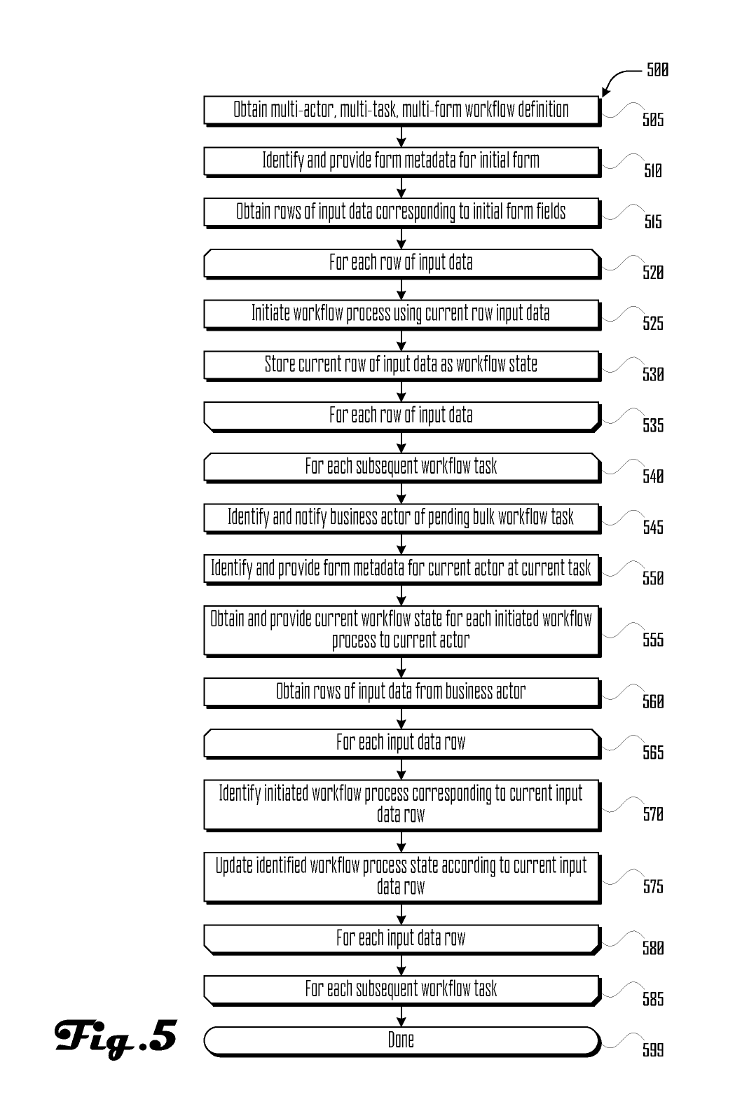

FIG. 5 illustrates a bulk workflow management routine 500, such as may be performed by bulk workflow server 200 in accordance with one embodiment. In block 505, routine 500 obtains a reusable business-process definition (“workflow definition”) including comprising two or more task definitions, each task definition being associated with at least one form views having one or more form fields for displaying and/or collecting data for a single instance of the task. Further, each defined task is specified as being associated with at least one business actor role for identifying a business actor to enter, review, validate, and/or approve data via the form view associated with the task. For example, in one embodiment, routine 500 may obtain a workflow definition describing a workflow such as that shown in user interface 900 of FIG. 9.

In block 510, routine 500 identifies an “initial” form view (the form view associated with the initial or originating task of the workflow) for displaying and/or collecting data via form fields to initiate a single instance of the workflow process. For example, in one embodiment, when processing a workflow defined such as shown in user interface 900, routine 500 may identify form 1000 (see FIG. 10) as being associated with the initial workflow task 905A.

In block 510, routine 500 further provides metadata associated with the initial form view to a remote client device, including metadata such as field names or descriptions, input options, validation rules, and the like. For example, a given form field may be associated with a list of input options that a user would choose among when filling out the form, such as by choosing a menu item from a pop-up or drop-down menu, selecting a radio button or option button from a group of radio or option buttons, or otherwise selecting among a list of options. In some embodiments, such a list of input options may be determined by performing a pre-defined query to obtain items from an ERP system or other database.

In other embodiments, a given form field may be associated with one or more validation rules, such as a non-empty rule (e.g., for required fields), a data-type rule (e.g., for numeric-only or text-only fields), a data-value rule (e.g., value must be greater or less than a predefined value, value must be shorter than a predefined number of characters and/or digits, or the like), or other like rules or combinations thereof.

Such form metadata (e.g., field names, input options, validation rules, and the like) are typically defined via a forms authoring tool and are typically obtainable based on the form definition. Typically, a remote client device would make use of such form metadata to provide a SLUI for displaying data to and/or collecting data from a business actor associated with a business-actor role (e.g., an individual accountant within the accounting department) to which the task is assigned.

In block 515, routine 500 obtains two or more rows of input data corresponding to the form metadata provided in block 510, the input data having been collected via a SLUI by the remote client device. For example, in one embodiment, having provided metadata associated with form 1000, routine 500 may obtain rows of data such as rows 1210A-D (see FIG. 12).

Beginning in opening loop block 520, routine 500 processes each row of input data in turn. In block 525, routine 500 initiates an individual workflow process (corresponding to the workflow definition obtained in block 505) using the current row of input data as if that input data had been collected via the form view identified in block 510. For example, when processing input data from row 1210A (see FIG. 12), routine 500 may initiate workflow process as if a remote business actor had entered the value “100-100” in field 1005A of form 1000 (see FIG. 10) and had entered the value “My material 100” in field 1005B of form 1000.

In block 530, routine 500 stores the current workflow state for use by subsequent tasks, as discussed below. In some embodiments, the current workflow state may include identifiers identifying each initiated workflow process (see, e.g., the “Process ID” column 1325G of FIG. 13). In closing loop block 535, routine 500 iterates back to block 520 to process the next row of input data (if any).

Once all rows of input data associated with the initial form view have been processed, in opening loop block 540, routine 500 processes each subsequent task of the workflow definition obtained in block 505. For example, when processing a workflow defined such as shown in user interface 900 (see FIG. 9), routine 500 may process subsequent tasks 905B-D. In some embodiments, some workflow tasks (e.g., task 905D) may not have an associated form and/or business actor or business actor role, and in such embodiments, routine 500 may automatically submit data and/or perform an automatic task as defined in the workflow definition (not shown).

In block 545, routine 500 identifies a business actor role associated with the current workflow task and notifies a business actor (who fills the identified role) that the workflow processes initiated in iterations of block 525 have pending tasks.

Upon request from a remote client device operated by the business actor notified in block 545, in block 550, routine 500 identifies a form associated with the current workflow task and provides form metadata (e.g., field names, input options, validation rules, and the like) associated with that form to the remote client device. For example, when processing workflow task 905B (see FIG. 9), routine 500 may identify form 1100 (see FIG. 11) as being associated with workflow task 905B and provide form metadata associated with that form to the remote client device.

In block 555, routine 500 obtains data corresponding to the current workflow state and provides that data to the remote client device to populate a SLUI for further collecting, displaying, reviewing/approving, and/or submitting data associated with the current tasks from the business actor. For example, when processing task 905B, routine 500 may obtain and provide current-state data corresponding to the input rows 1210A-D as provided by a previous business actor when completing a previous workflow task.

In block 560, routine 500 obtains two or more rows of input data corresponding to the form metadata provided in block 550, the input data having been collected via a SLUT by the remote client device. For example, in one embodiment, having provided metadata associated with form 1100, routine 500 may obtain rows of data such as rows 1310A-D (see FIG. 13).

Beginning in opening loop block 565, routine 500 processes in turn each row of input data obtained in block 560. In block 570, routine 500 identifies an individual workflow process corresponding to the current row of input data (e.g., using a process identifier such as shown in column 1325G of input rows 1310A-D).

In block 575, routine 500 updates the current workflow state as if the business actor identified in block 545 had provided the current row of input data via the form identified in block 550, thereby advancing the current workflow by completing the current task. In various embodiments, advancing the current workflow may include performing various form-defined operations such as validating one or more input values against data stored in an Enterprise Application system and/or storing one or more input values into an Enterprise Application system.

In closing loop block 580, routine 500 iterates back to block 65 to process the next row of input data (if any). Once all rows of input data have been processed, in closing loop block 585, routine 500 iterates back to block 540 to process the next workflow task (if any). Once all tasks have been processed, routine 500 ends in block 599.

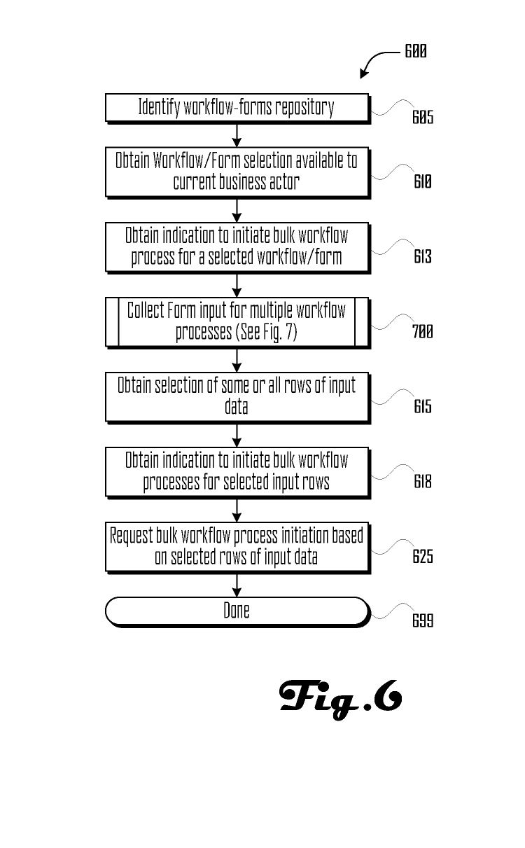

FIG. 6 illustrates a bulk workflows initiation routine 600, such as may be performed by a client device 300 in accordance with one embodiment. In block 605, routine 600 identifies a repository of workflow definitions and/or workflow forms, such as may be maintained by bulk workflow server 200. For example, in one embodiment, routine 600 may be performed by or in connection with a bulk-forms add-in to a general-purpose spreadsheet application (such as that depicted in user interface 1200) and/or a similar dedicated bulk-forms application (e.g., desktop application, web application, mobile application, or the like). In such an embodiment, routine 600 may identify the repository of workflow definitions and/or workflow forms in block 605 by obtaining a forms-repository identifier from the user, such as via input field 1215A.

In block 610, routine 600 identifies the current business actor (e.g., the user who is providing input via a user interface such as user interface 1200) and obtains a list of one or more workflows and/or workflow forms that are available to the current business actor. For example, in one embodiment, routine 600 may query the workflow repository identified in block 605 to obtain a list of forms to populate a selection control such as menu 1215B.

In block 613, routine 600 obtains an indication from the user to initiate bulk-workflow processes for a selected workflow and/or form. For example, in one embodiment, the user may make a form selection using control 1215B and indicate to initiate bulk-workflow processes by activating control 1220A.

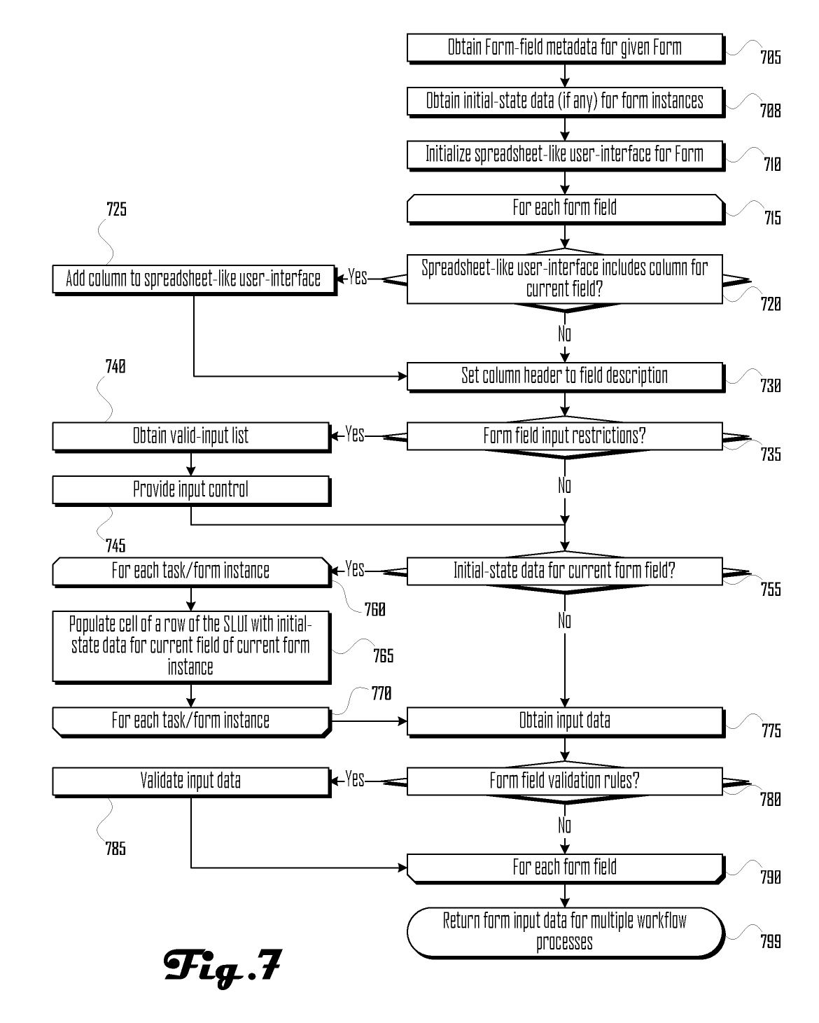

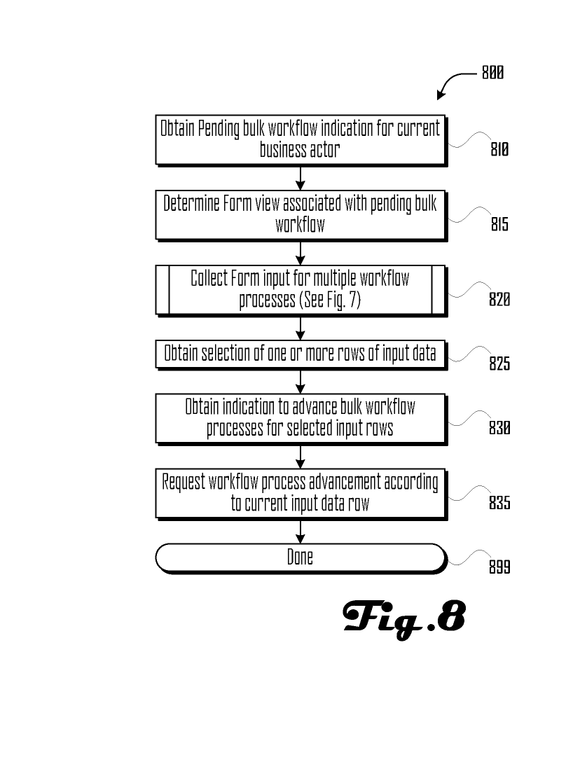

In subroutine block 700, routine 600 calls subroutine 700 (see FIG. 7, discussed below) to collect input for multiple workflow processes via a SLUI. In block 615, routine 600 obtains a user-selection of indicating two or more rows of input data from which the business actor wishes to initiate two or more workflow processes in bulk. In block 618, routine 600 obtains an indication that the business actor wishes to initiate bulk workflow processes corresponding to the selected input rows. For example, in one embodiment, when using user interface 1200, a business actor may select two or more of input data rows 1210A-D and activate control 1220B.

In block 625, routine 600 requests to initiate bulk workflow processes based on the selected rows of input data. For example, in one embodiment, routine 600 may communicate with routine 500 or a similar routine performed by bulk workflow server 200, providing the selected rows of input data for processing to bulk-initiate a workflow process per row.

Having requested initiation of bulk workflow processes based on the selected rows of input data, routine 600 ends in block 699.

FIG. 7 illustrates a subroutine 700 for populating a SLUI to collect input for a given form associated with a given task of multiple workflow processes, such as may be performed by a client device 300 in accordance with one embodiment. In block 705, subroutine 700 obtains form-field metadata describing various attributes of one or more form fields of the given form. For example, in one embodiment, subroutine 700 may obtain form-field metadata (e.g., field names, input options, validation rules, and the like) from bulk workflow server 200.

In block 708, subroutine 700 obtains data (if any) indicating a starting state for two or more task/form instances in the given bulk-workflow processes. For example, when processing SLUI 1300 in connection with instances of task 905B, subroutine 700 may obtain starting-state data (e.g., from bulk workflow server 200) corresponding to columns 1225A-B and rows 1210A-D of input data that were provided by an originating business actor via SLUT 1200.

In block 710, subroutine 700 initializes a spreadsheet-like user interface for entering, reviewing, validating, and/or approving data for multiple instances of the given task. For example, in one embodiment, initializing a spreadsheet-like user interface may include creating a new spreadsheet document. In other embodiments, initializing a spreadsheet-like user interface may include initializing a data structure to store cells of data organized in rows and columns.

In opening loop block 715, subroutine 700 processes each form field indicated by the form-field metadata obtained in block 705. In decision block 720, subroutine 700 determines whether the SLUI initialized in block 710 already includes a column corresponding to the current form field. For example, if initializing the SLUI in block 715 included creating a new spreadsheet document, the spreadsheet document may have been initialized with several empty rows and columns of cells. On the other hand, if initializing the SLUI in block 715 included initializing an data structure, the data structure may or may not have been initialized with rows or columns for organizing cells of data.

If the SLUI initialized in block 710 is determined to not include a column corresponding to the current form field, then in block 725, subroutine 700 adds a column to the SLUI. Otherwise, subroutine 700 proceeds to block 730, in which subroutine 700 sets the header of the column to match the name or description of the current form field as indicated by the form-field metadata obtained in block 705. For example, in one embodiment, when processing a SLUT such as SLUT 1300 (see FIG. 13), subroutine 700 may set the header-row (row 1305) cell of column 1325A to “Material Number”, which matches the name or description of the corresponding field 1105A of form 1100 (see FIG. 11).

In decision block 735, subroutine 700 determines whether the form-field metadata obtained in block 705 indicates that the current form field has any input restrictions. If so, then in block 740, subroutine 700 obtains a list of one or more valid input options (e.g., by parsing the form-field metadata obtained in block 705 and/or by querying bulk workflow server 200 and/or an Enterprise Application system according to the form-field metadata obtained in block 705), and in block 745, subroutine 700 provides an input control to allow a user to select among the input options to populate cells in the column corresponding to the current form field. For example, in one embodiment, subroutine 700 may provide a drop-down or pop-up list for each cell in the column corresponding to the current form field.

In decision block 755, subroutine 700 determines whether any initial-state data for the current field was provided in block 708. If so, then in opening loop block 760, subroutine 700 processes each task/form instance that is pending in the given workflow processes.

In block 765, subroutine 700 identifies a row of the SLUI that corresponds to the current task/form instance and populates with an initial-state value a cell at the intersection of that row and the column corresponding to the current form field. For example, when processing a first instance of task 905B/form 1100, subroutine 700 may populate the cell at the intersection of row 1310A and column 1325A with an initial-state value of “100-100”; when processing a second instance of task 905B/form 1100, subroutine 700 may populate the cell at the intersection of row 1310B and column 1325A with an initial-state value of “100-101”, and so on.

In closing loop block 770, subroutine 700 iterates back to block 760 to process the next task/form instance (if any). Once all task/form instances have been processed, subroutine 700 proceeds to block 775, in which subroutine 700 obtains input data from a business actor operating the device on which subroutine 700 is being performed. For example, in one embodiment, the business actor may enter a data such as that shown in SLUI 1300 in rows 1310A-D and column 1325C (when processing form field 1105C), column 1325D (when processing form field 1105D), and so on.

In decision block 780, subroutine 700 determines whether the current form field has any validation rules or restrictions (as indicated by the metadata obtained in block 705). If so, then in block 785, subroutine 700 validates the input data provided in the column corresponding to the current form field.

In closing loop block 790, subroutine 700 iterates back to block 715 to process the next form field (if any). Once all form fields are processed, subroutine 700 ends in block 799, returning the rows of input data to the caller.

FIG. 8 illustrates an in-process bulk workflows processing routine 800, such as may be performed by a client device 300 in accordance with one embodiment. In block 810, routine 800 obtains an indication that one or more bulk workflow processes have pending tasks for the current business actor (e.g., the user operating the device performing routine 800). For example, in one embodiment, routine 800 may receive a pending-bulk-workflows notification from bulk workflow server 200.

In block 815, routine 800 determines a form or form view that is associated with the pending bulk-workflow processes. For example, in one embodiment, when notified that task 905B is pending in bulk workflow processes, a business actor using user interface 1300 may activate control 1320C to determine (e.g., by querying bulk workflow server 200) that form 1100 is associated with the pending workflow processes and to obtain data for advancing the pending processes.

In subroutine block 700, routine 800 calls subroutine 700 (see FIG. 7, discussed below) to collect input for multiple workflow processes via a SLUI. In block 825, routine 800 obtains a user-selection of indicating two or more rows of input data from which the business actor wishes to advance the bulk workflow processes.

In block 830, routine 800 obtains an indication that the business actor wishes to advance the pending bulk workflow processes corresponding to the selected input rows. For example, in one embodiment, when using user interface 1300, a business actor may select two or more of input data rows 1310A-D and activate control 1320D.

In block 835, routine 800 requests to advance the bulk workflow processes based on the selected rows of input data. For example, in one embodiment, routine 800 may communicate with routine 500 or a similar routine performed by bulk workflow server 200, providing the selected rows of input data for processing to bulk-advance a workflow process corresponding to each row. Having requested advancement of bulk workflow processes based on the selected rows of input data, routine 800 ends in block 899.

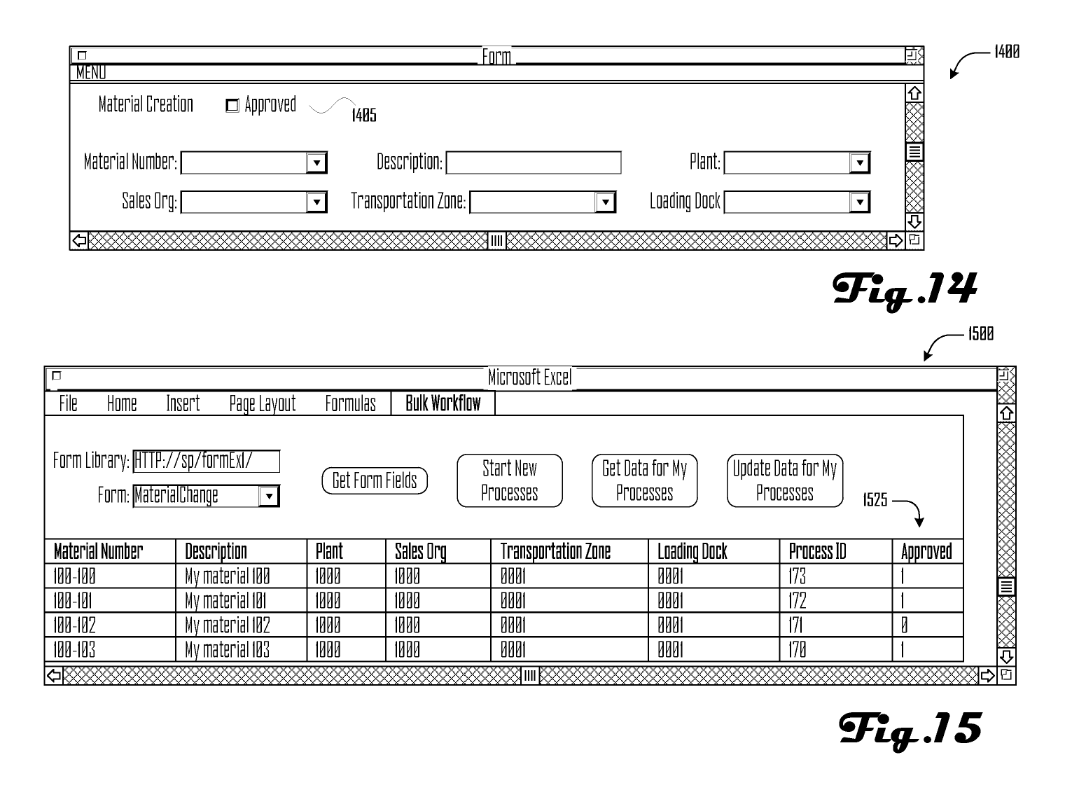

Form 1400, as illustrated in FIG. 14, is similar to form 1100 (see FIG. 11, discussed above), but form 1400 includes a control 1405 for a reviewer/approver to mark the form contents as approved. Similarly, SLUT 1500 is similar to SLUI 1300 (see FIG. 13, discussed above), but SLUT 1500 includes a column 1525, corresponding to control 1405, for indicating that rows are approved or not.

Although specific embodiments have been illustrated and described herein, it will be appreciated by those of ordinary skill in the art that a whole variety of alternate and/or equivalent implementations may be substituted for the specific embodiments shown and described without departing from the scope of the present invention. For example, although the description above refers to SLUIs in which columns of cells correspond to form fields, and rows of cells correspond to form/workflow instances. In other embodiments, an equivalent SLUI may transform these relationships such that columns of cells correspond to form/workflow instances, and rows of cells correspond to form fields.

Similarly, in some embodiments, a form may include a repeating section or an internal table (e.g., a sales order form with header and line items). In such embodiments, a SLUI may be configured in a manner similar to that shown in Table 1, below.

TABLE 1
Example Header/Line Item SLUI configuration

| Indicator | Customer | Sales.Org | Item | Unit Price | Quantity |
|---|---|---|---|---|---|
| Header | ABC, Inc. | Seattle | | | |
| Item | | | Golf Club | 100 | 10 |
| Item | | | Golf Ball | 1 | 100 |
| Item | | | Glove | 10 | 10 |

This application is intended to cover any adaptations or variations of the embodiments discussed herein.

1. A computer-implemented method for managing a plurality of parallel business workflow processes in bulk, the method comprising:
obtaining, by the computer, a reusable business process definition comprising a plurality of task definitions, said plurality of task definitions being respectively associated with a plurality of form views, each form view having one or more form fields for displaying and/or collecting data for a single task instance, said plurality of task definitions being further respectively associated with a plurality of business actor roles for identifying business actors to enter, review, validate, and/or approve data via one of said plurality of form views;
identifying, by the computer among said plurality of form views, an initial form view for displaying and/or collecting data via a plurality of initial-form fields to initiate a single instance of a business process corresponding to said reusable business process definition;
providing, by the computer, said plurality of initial-form fields and associated metadata for presentation to a business actor via a spreadsheet-like interface for displaying and/or collecting data for multiple instances of each of said plurality of initial-form fields;
obtaining business-actor-provided input data, provided via said spreadsheet-like interface, comprising a plurality of input groups, each input group including a plurality of input values corresponding respectively to said plurality of initial-form fields;
initiating, by the computer, a plurality of instances of said business process; and
for each business process instance, storing input data from one of said plurality of input groups as a current-instance state as if said input data had been collected for the current instance via said initial form view.

2. The method of claim 1, wherein said plurality of input groups correspond respectively to a plurality of rows of said spreadsheet-like interface, and wherein for each group of said plurality of input groups, the plurality of input values of the current group correspond respectively to a plurality of cells of a corresponding one of said plurality of rows.

3. The method of claim 1, further comprising:
identifying a subsequent form view for displaying and/or collecting data via a plurality of subsequent-form fields to perform a subsequent task defined among said plurality of task definitions;
identifying at least one subsequent business actor to fill a business actor role associated with said subsequent task;
notifying said at least one subsequent business actor that said subsequent task is pending in said plurality of parallel instances of said business process;
for each business process instance, providing current-instance state data to populate at least some cells of a cell group of a second spreadsheet-like interface for displaying and/or collecting data to perform said subsequent task for each of said plurality of instances of said business process.

4. The method of claim 3, further comprising:
obtaining subsequent business-actor-provided input data, provided via said second spreadsheet-like interface, comprising a plurality of subsequent input groups, each subsequent input group including a plurality of subsequent input values corresponding respectively to said plurality of subsequent-form fields;
for each group of said plurality of subsequent input groups:
identifying one of said plurality of instances of said business process as corresponding to the current group; and
advancing the identified business-process instance using a plurality of subsequent input values of the current group, as if the plurality of subsequent input values of the current group had been collected for the identified business-process instance via said subsequent form view

5. The method of claim 3, wherein for each business process instance, providing current-instance state data comprises retrieving data from an Enterprise Application system to populate said at least some cells of said cell group of said second spreadsheet-like interface.

6. The method of claim 4, wherein for each group of said plurality of subsequent input groups, advancing the identified business-process instance includes at least one of the following operations:
validating at least one of said plurality of subsequent input values against data stored in an Enterprise Application system; and
storing at least one of said plurality of subsequent input values into said Enterprise Application system.

7. A non-transient computer-readable storage medium having stored thereon instructions that, when executed by a processor, perform the method of claim 1.

8. A computing apparatus comprising a processor and a memory having stored thereon instructions that, when executed by the processor, perform the method of claim 1.

9-14. (canceled)
